(19) United States
(12) Patent Application Publication
(10) Pub. No.: US 2004/0193430 A1
(43) Pub. Date: Sep. 30, 2004

(54) Method and apparatus for mixing audio stream and information storage medium thereof

(75) Inventors: Jung-Kwon Heo, Seoul (KR); Sung-wook Park, Seoul (KR); Hyun-Kwon Chung, Seoul (KR); Kil-soo Jung, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon City (KR)

(21) Appl. No.: 10/746,553

(22) Filed: Dec. 29, 2003

(30) Foreign Application Priority Data
Oct. 10, 2003 (KR) 2003-70749
Dec. 28, 2002 (KR) 2002-85906

(51) Int. Cl. G10L 19/00

(52) U.S. Cl. 704/500

(57) ABSTRACT

A method and apparatus for mixing audio streams, and an information storage medium that stores mixing information. The information storage medium includes at least one audio stream that contains a multiplicity of audio data obtained from respective multiple channels, and mixing information used to mix at least parts of the multiplicity of audio data. Accordingly, it is possible to mix and reproduce different types of channel components without changing the channel formats of different audio streams. Furthermore, it is also possible to perform dynamic mixing on multiple channel components, thus enabling adaptation to a change in audio content and characteristics thereof and thereby reproducing audio data more appropriately. In particular, since mixing information is described in interactive data allowing an interaction with a user, it is possible to provide the user with more applications.

### CROSS-REFERENCE TO RELATED APPLICATIONS

This application claims the priorities of Korean Patent Application Nos. 2002-85906 filed on Dec. 28, 2002 and 2003-70749 filed on Oct. 10, 2003, in the Korean Intellectual Property Office, the disclosures of which are incorporated herein in their entirety by reference.

### BACKGROUND OF THE INVENTION

1. Field of the Invention

The present invention relates to a method and apparatus for mixing a multiplicity of audio data obtained from respective multiple channels.

2. Description of the Related Art

FIG. 1 is a schematic view of a conventional user interface for adjusting the volume of an audio player installed in a personal computer (PC) or the like. A user can adjust the volume of the audio player using a volume control interface as shown in FIG. 1. When the user adjusts the volume of the audio player by raising or lowering a volume button 100 with a keyboard or a mouse, audio mixing is simultaneously performed on audio data obtained from respective multiple channels. Audio mixing, however, is arbitrarily determined by the audio player, regardless of the number of audio stream channels and the types of channels.

For instance, when reproducing an audio stream containing audio data obtained from two channels, the output levels of first audio data from a first channel and second audio data from a second channel are predetermined in the audio player. Thus, the output levels of the first and second audio data are adjusted to the preset output levels, and the adjusted output-levels of the first and second audio data are mixed.

However, the above arbitrary audio mixing has some problems. First, it is impossible for a content provider to provide first audio data and second audio data obtained from two separate channels at the same time, while adjusting the output levels to desired levels and mixing the first and second audio data. This is because present audio mixing techniques do not allow audio mixing while reflecting content providers' intentions. In other words, since the output levels of audio data are adjusted and audio mixing is performed as predetermined in an audio player installed in a personal computer, it is almost impossible to appropriately reflect a content producer's intention in audio mixing.

Secondly, once an audio mixing method is determined with respect to audio content, such as the words of a song or a movie script, the mixing method is maintained until completion of reproduction thereof. That is, it is impossible to dynamically change the audio mixing method performed on audio content. Thus, no adaptation can be made to any audio content or characteristics.

Thirdly, only the same type of channel components can be mixed when mixing channel components of one type of audio content with those components of another type of audio content. In other words, even though content providers want to provide audio contents obtained by mixing audio data from different channels, it is impossible to make such contents. In particular, if one type of audio content contains multichannel data and another type of audio content contains two-channel data, it is difficult to mix the two-channel data with the surround component of the multichannel data without changing the channel format of the two-channel data. In order to mix the two-channel data with a channel component of multichannel data, the two-channel data needs to be transformed into a multichannel data format, that is, the channel format thereof must be changed before transmission. Thus, the transmission of the two-channel data requires use of resources dedicated to the multichannel data, thus resulting in a waste of resources. In particular, this problem becomes serious when simultaneously reproducing a piece of MP3 music downloaded via the Internet while reproducing video containing a multi-channel audio component, such as DVD-Video. The MP3 music includes two channels, i.e., right and left channels. Thus, during the reproduction of a DVD-Video, MP3 channel audio data from the right and left channels is mixed only with right and left channel audio data of the multi-channel audio contained in the DVD-Video, respectively. Also, the output levels of mixed audio data need to be changed depending on the characteristics of an audio player. Therefore, it is difficult for a content provider to adjust the MP3 music to a desired output level, and mix the MP3 music with surround multichannel channel audio data contained in the DVD-Video.

### SUMMARY OF THE INVENTION

The present invention provides an audio mixing method and apparatus capable of mixing and reproducing different types of channel components without changing the channel formats of audio streams, which constitute different types of audio content, and an information storage medium that stores audio mixing information.

The present invention also provides an audio mixing method and apparatus capable of dynamically changing the audio mixing method performed on multiple channel components, thus enabling a change in audio content or characteristics, and an information storage medium that stores audio mixing information.

According to an aspect of the present invention, there is provided an information storage medium comprising at least one audio stream that contains a multiplicity of audio data obtained from respective multiple channels, and mixing information used to mix at least parts of the multiplicity of audio data.

The mixing of information comprises mixing coefficient information used to adjust output levels of audio data. Also, the mixing of information further comprises mixing-relation information that specifies audio data obtained from the multiplicity of audio data.

The mixing information is recorded in program data which enables an interaction with a user. The program data comprises java data created with a java programming language.

According to another aspect of the present invention, there is provided an information storage medium comprising a first audio stream containing a multiplicity of audio data obtained from respective multiple channels, a second audio stream containing a multiplicity of audio data obtained from respective multiple channels, and mixing information that is recorded in interactive data to mix at least one audio data from the first audio stream with at least one audio data from the second audio stream.

The mixing information is recorded in program data which enables interaction with a user, based on an interface defined between a platform reading the mixing information and a java language implementing the mixing information. The program data comprises java data created with a java programming language.

According to yet another aspect of the present invention, there is provided a method of reproducing an audio stream, the method including decoding at least one audio stream containing a multiplicity of audio data obtained from respective multiple channels; and mixing audio data from at least two channels of the multiple channels, based on mixing information recorded in interactive data.

According to still another aspect of the present invention, there is provided an apparatus which reproduces an audio stream, the apparatus including a decoder that decodes an audio stream containing a multiplicity of audio data obtained from respective multiple channels, and a mixer that mixes at least two parts of the decoded audio data based on mixing information.

According to still another aspect of the present invention, there is provided an apparatus that reproduces an audio stream, the apparatus including a decoder that decodes a first audio stream containing a multiplicity of audio data obtained from respective multiple channels and decodes a second audio stream containing a multiplicity of audio data obtained from respective multiple channels; and a mixer that mixes audio data from at least one channel of the multiple channels for the first audio stream and audio data from at least one channel of the multiple channels for the second audio stream, based on mixing information. The mixing information is recorded in interactive data.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view of a conventional user interface for adjusting the volume of an audio player installed in a personal computer (PC) or the like;

FIG. 2A is a block diagram illustrating the structure of a reproducing apparatus according to an embodiment of the present invention;

FIG. 2B is a block diagram illustrating the structure of an embodiment of the reproducing apparatus of FIG. 2A;

FIGS. 3A and 3B illustrate examples of an audio stream containing a multiplicity of audio data obtained from respective multiple channels, according to the present invention;

FIG. 4 is a block diagram illustrating the structure of another embodiment of the reproducing apparatus of FIG. 2A that mixes the first audio stream of FIG. 3A and the second audio stream of FIG. 3B;

FIG. 5 illustrates a data structure of mixing information according to an embodiment of the present invention;

FIG. 6 illustrates a mixing table containing the mixing information of FIG. 5, according to an embodiment of the present invention;

FIG. 7 is a reference diagram illustrating dynamic mixing according to the present invention;

FIG. 8 illustrates an example of programming code of an interface, such as an application program interface (API), that defines mixing information according to the present invention;

FIG. 9 illustrates an example of code of the interface of FIG. 8 that defines mixing information added to a markup document using ECMAScript;

FIG. 10 illustrates an example of code of a JAVA Package that defines IDL Definition shown in FIG. 8 so as to use the IDL Definition in a java program;

FIG. 11 illustrates an example of code of a java program to which mixing information is added using the JAVA Package of FIG. 10;

FIG. 12 is a flowchart illustrating a method of reproducing an audio stream according to an embodiment of the present invention;

FIG. 13 is a flowchart illustrating a method of reproducing an audio stream according to another embodiment of the present invention; and

FIGS. 14A and 14B illustrate embodiments of operation 1306 of FIG. 13.

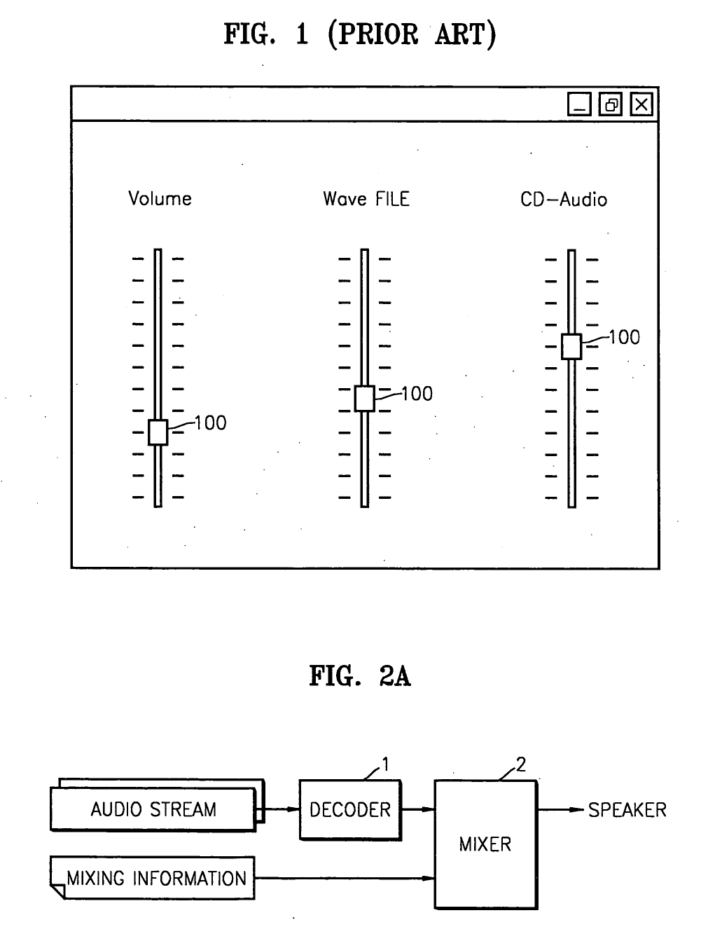

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

For a better understanding of the present invention, ‘mixing’ according to the present invention will be explained first. Mixing can be understood as one of the following: (i) adjusting the output levels of audio data from at least two channels of a multichannel audio stream; (ii) adjusting the respective output levels of audio data from at least two respective channels of a multichannel audio stream, and combining the adjusted audio data from one channel with audio data from at least one other channel; and (iii) combining audio data from respective multiple channels of a multichannel audio stream, and outputting the combination result to a speaker. Also, mixing methods (i) through (iii) are applicable to audio data from respective multiple channels of multiple multichannel audio streams. Further, dynamic mixing includes ‘mixing’ according to the present invention.

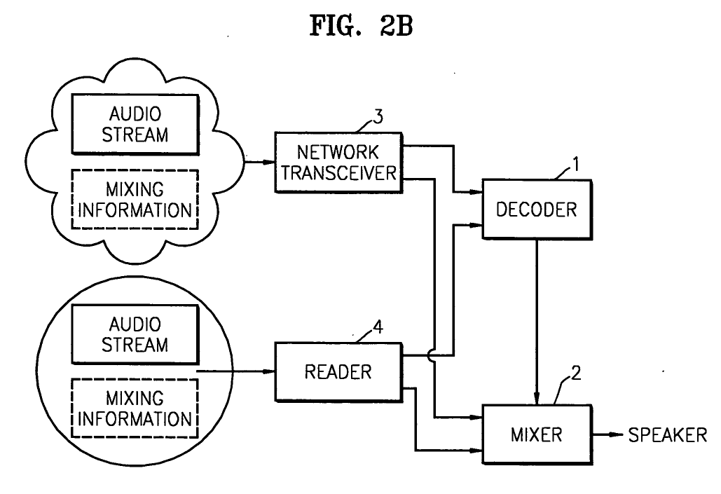

FIG. 2A is a block diagram illustrating the structure of a reproducing apparatus according to an embodiment of the present invention. Referring to FIG. 2A, the reproducing apparatus mixes the audio data from at least one multichannel audio stream, based on mixing information according to the present invention. The reproducing apparatus includes a decoder 1 and a mixer 2. The decoder 1 decodes a multichannel audio stream which contains a multiplicity of audio data distinguished by its respective multiple channels. The mixer 2 mixes the decoded multiplicity of audio data based on the mixing information. More specifically, the mixer 2 adjusts the output levels of audio data from multiple audio streams, and combines the audio data contained in an audio stream with the audio data contained in another audio stream, based on the mixing information. When an audio stream contains a multiplicity of mixing information regarding an audio stream, the mixer 2 performs dynamic mixing on the audio stream by adjusting the output levels according to the contents or other conditions. Dynamic mixing will be described later in detail.

FIG. 2B is a block diagram illustrating the structure of an embodiment of the reproducing apparatus of FIG. 2A. Referring to FIG. 2B, the recording apparatus includes a decoder 1, a mixer 2, a network transceiver 3, and a reader 4. The network transceiver 3 transmits information to and receives information from a network. In particular, the network transceiver 3 according to the present invention receives audio stream and/or mixing information via the network. The reader 4 reads an audio stream and/or mixing information from a disc-type information storage medium such as a hard disk (HD), a compact disc (CD), or a digital versatile disc (DVD). The multiplicity of audio data in an audio stream is obtained from respective multiple channels and is distinguished by respective channels. The mixing information can be obtained either through a network or from a disc-type information storage medium. A detailed description of the mixing information will be provided later.

The decoder 1 decodes first and second audio streams provided by the network transceiver 3 or the reader 4. The mixer 2 mixes the decoded audio data from the first multichannel audio stream with the decoded audio data from the second multichannel audio stream, based on mixing information obtained from the network transceiver 3 or the reader 4. More specifically, the mixer 2 adjusts the output level of audio data from each of the audio streams, combines the audio data contained in one audio stream with the audio data contained in the other audio stream, based on the mixing information, and transmits the combination result to a speaker.

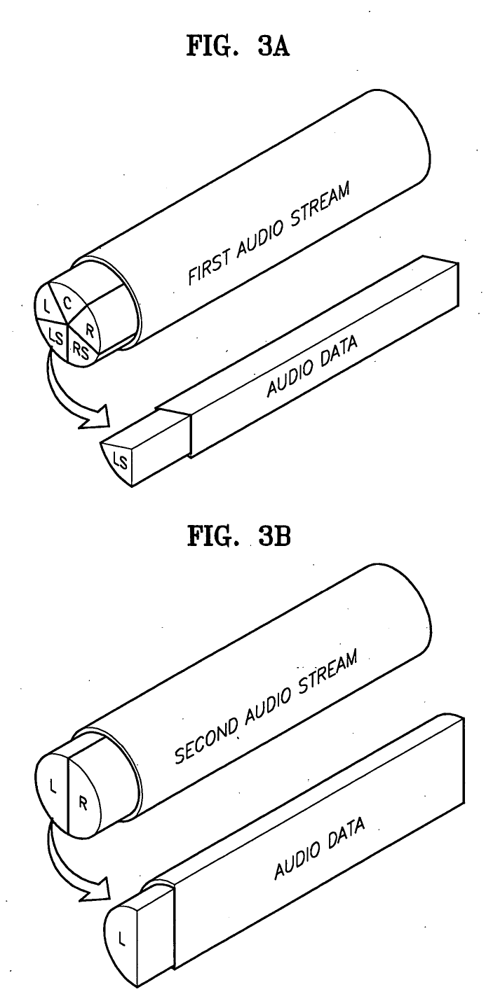

FIGS. 3A and 3B illustrate examples of an audio stream containing a multiplicity of audio data obtained from respective multiple channels, according to the present invention.

Referring to FIG. 3A, a first audio stream contains audio data that is obtained from the five channels L, C, R, LS, and RS. Here, L, C, R, LS, and RS denote a left channel, a central channel, a right channel, a left-surround channel, and a right-surround channel, respectively. The channels L, R, and C provide stable virtual sound sources and the channels LS and RS provides three-dimensional (3D), realistic sound sources. According to the present invention, the multiplicity of audio data contains respective channel information. For instance, if audio data is obtained from the channel LS, the channel information contained in the audio data indicates the audio data corresponds to the channel LS.

Referring to FIG. 3B, a second audio stream contains audio data that is obtained from two channels L and R. Here, L and R denote a left channel and a right channel, respectively. The second audio stream, i.e., two-channel audio stream, enables reproduction of sound that echoes in right and left directions. As explained with respect to FIG. 3A, the respective audio data from the respective channels contains corresponding channel information. For instance, if audio data is obtained from the channel L, the channel information contained in the audio data indicates the audio data corresponds to the channel L.

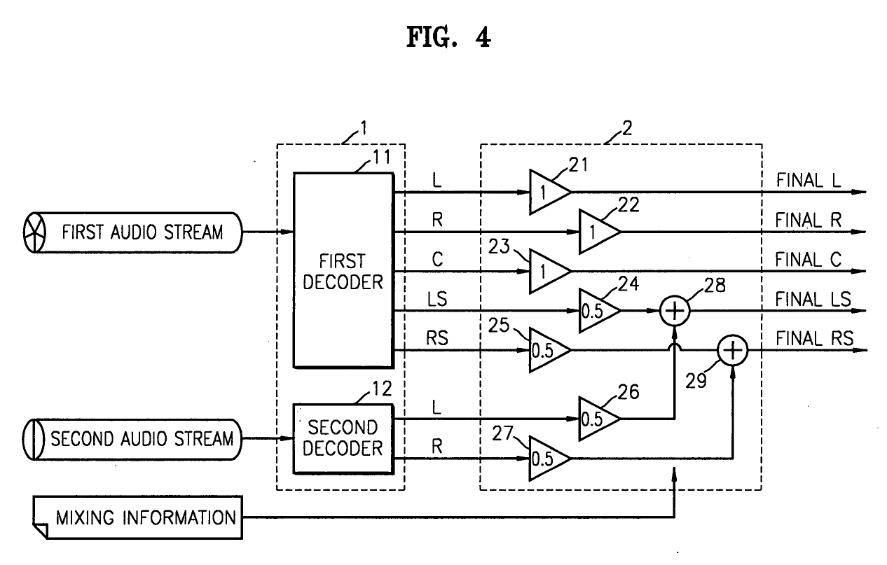

FIG. 4 is a block diagram illustrating the structure of another embodiment of the reproducing apparatus of FIG. 2A that mixes the first audio stream of FIG. 3A and the second audio stream of FIG. 3B. Referring to FIG. 4, the reproducing apparatus includes a decoding unit 1 having a first decoder 11, a second decoder 12, and a mixer 2. The first decoder 11 decodes a first audio stream containing audio data corresponding to five channels and separately outputs the decoded audio data according to the five channels L, R, C, LS, and RS. The output audio data is sent to the mixer 2 as five separate channel data. The second decoder 12 decodes a second audio stream containing audio data corresponding to the two channels L and R and separately outputs the decoded audio data according to the two channels L and R. The output audio data is also sent to the mixer 2 as two separate channel data.

The mixer 2 includes amplifiers 21 through 27 which amplify the output levels of the audio data input from the first decoder 11 and the second decoder 12, and includes adders 28 and 29 that combine a multiplicity of audio data from at least two channels. In FIG. 4, two adders, i.e., the adders 28 and 29, are specified as an example, but there is no restriction to the number of adders. If necessary, the mixer 2 according to the present invention may include more adders for combining audio data from channels not shown in FIG. 4.

Based on mixing information, the mixer 2 uses the amplifiers 21 through 23 to multiply the output levels of audio data from the channels L, R, and C, which are input from the first decoder 11, by a mixing coefficient of 1, and uses the amplifiers 24 and 25 to multiply the output levels of audio data from the channels LS and RS by a mixing coefficient of 0.5. Similarly, based on the mixing information, the mixer 2 uses the amplifiers 26 and 27 to multiply the output levels of audio data from the channels L and R, which are input from the second decoder 12, by a mixing coefficient of 0.5 using the amplifiers 26 and 27. Next, the mixer 2 uses the adders 28 and 29 to combine the audio data having adjusted output levels with the audio data from the channels LS and RS. That is, audio data from channel L of the second audio stream and audio data from channel R of the second audio stream are combined with the audio data from the channels LS and RS of the first audio stream, respectively. The results of the combinations are output via the channels LS and RS. Thus, the mixer 2 outputs final audio data via the five channels L, R, C, LS, and RS.

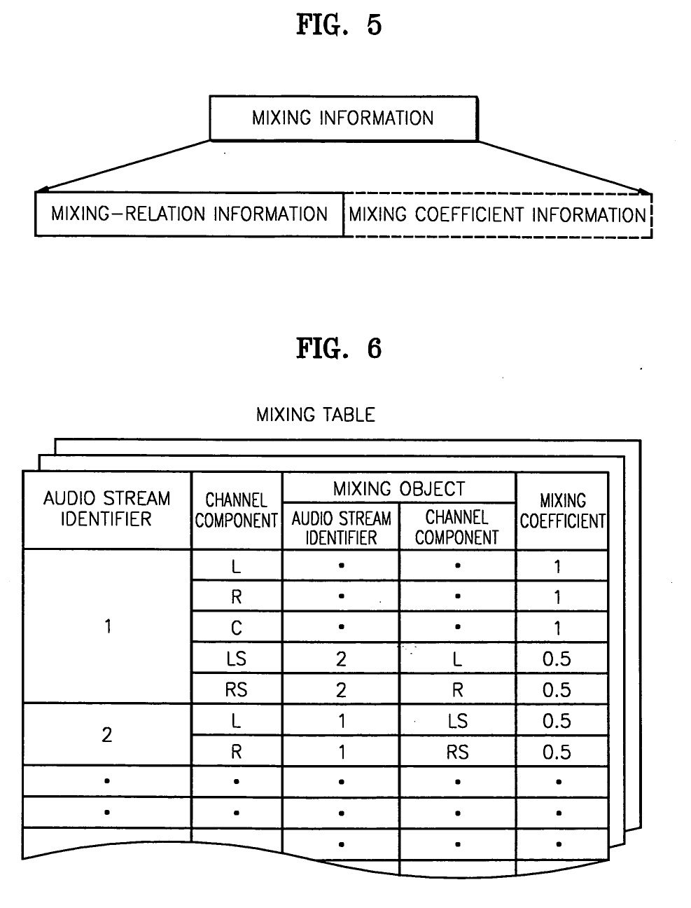

FIG. 5 illustrates a data structure of mixing information according to an embodiment of the present invention. Referring to FIG. 5, the mixing information contains mixing-relation information and/or mixing coefficient information. The mixing-relation information specifies from a multiplicity of audio data which audio data is selected and combined, and the mixing coefficient information specifies mixing coefficients that are used when adjusting the output levels of audio data that will be mixed. Alternatively, the mixing information may include only one of the mixing-relation information and the mixing coefficient information.

FIG. 6 illustrates a mixing table containing the mixing information of FIG. 5, according to an embodiment of the present invention. Referring to FIG. 6, the mixing table, which is used by the mixer 2 included in the reproducing apparatus of FIG. 4, contains mixing information that includes mixing-relation information and mixing coefficient information. In detail, the mixing-relation information specifies identifiers for audio streams input to the mixer 2; channel components of the audio streams input to the mixer 2; audio stream identifiers and channel components that are to be combined with the channel components of another subsequent audio stream; and mixing coefficients used for adjusting the output levels of audio data. The mixing table reveals that the output levels of audio data obtained from channels L, R, and C of a first audio stream are multiplied by a mixing coefficient of 1, and the output levels of audio data from channels LS and RS are multiplied by a mixing coefficient of 0.5. That is, the output levels of audio data from the channels LS and RS are reduced by half, and the adjusted audio data is combined with audio data from the channels L and R of a second audio stream. Meanwhile, the output levels of audio data from the channels L and R of the second audio stream are multiplied by a mixing coefficient of 0.5. That is, the output levels of audio data from the channels L and R of the second audio stream are also reduced by half and the adjusted audio data is combined with the audio data from the channels LS and RS of the first audio stream.

For instance, if the first audio stream is an AC3 stream and the second audio stream is an MP3 stream, the mixer 2 reduces the output levels of audio data from channels LS and RS of the AC3 stream by half; reduces the output levels of audio data from channels L and R of the MP3 stream by half; combines the adjusted audio data from the channels LS and RS, and the adjusted audio data from the channels L and R; and transmits the combined data through the channels LS and RS, as specified in the mixing table.

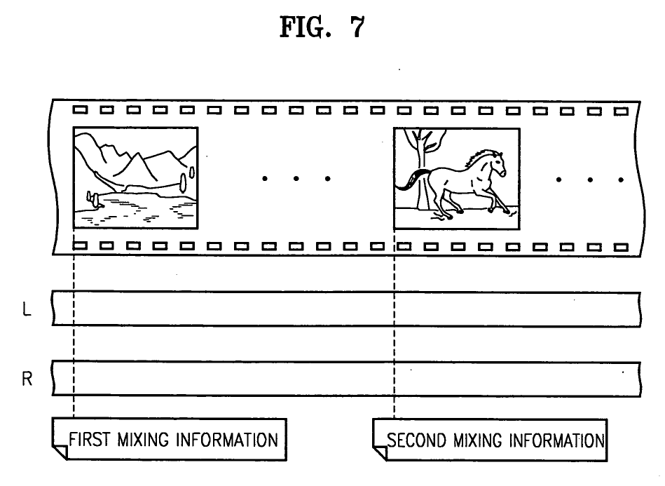

FIG. 7 is a diagram illustrating dynamic mixing according to the present invention. In detail, FIG. 7 illustrates an audio stream, which contains audio data obtained from respective channels L and R, the audio stream reproduced together with video data. In this case, it might not be preferable to use a fixed mixing coefficient when reproducing. For example, this might apply when a movie is shown with a movie producer's narration. If the narration is reproduced at the same output level in both a quiet scene and a noisy battle scene, the output level might be too high to match the atmosphere of the quiet scene or too low during the noisy battle scene. To solve this problem, it is recommended that a content provider provide a plurality of mixing tables which lists mixing coefficients for appropriately adjusting the output levels of audio data to match the atmospheres of respective scenes in a movie. If the number of mixing tables is more than one, reference timing information should be further provided. The reference timing information specifies instances in time when the mixer 2 of the reproducing apparatus, shown in FIG. 4, should refer to the plurality of mixing tables. The mixer 2 enables dynamic mixing by adjusting the output levels of different audio data as instructed by the reference timing information, in which the output levels are multiplied by different mixing coefficients listed in the plurality of mixing tables. Mixing according to the present invention includes the dynamic mixing in which audio mixing is performed based on different mixing information at different points of time when the contents are reproduced, according to contents and a content provider's intention.

Mixing information according to the present invention may be included in interactive data stored together with audio/video (AV) data, e.g., high-definition movie data, in a conventional DVD-video format. The interactive data indicates markup data and/or programming data used to detect AV data for an interaction with a user or while browsing the Internet. The markup data indicates a markup document described in a markup language such as Hyper Text Markup Language (HTML) or extensible Markup Language (XML); or a markup resource, such as a graphics file, an image file, or a sound file, which is inserted into a markup document. The programming data indicates a program file that is included in a markup document or made separately from a markup document, and provides a user with various applications. In general, the programming data is made of a script language or a java language.

For instance, mixing information in an interactive data format is an application program interface (API). For the API, an interface between a particular platform that reproduces mixing information stored in an information storage medium such as a DVD, and a particular language in which the mixing information is described must be defined. The particular language may be JAVAScript or ECMAScript in markup data, or corresponds to JAVA Language in java data.

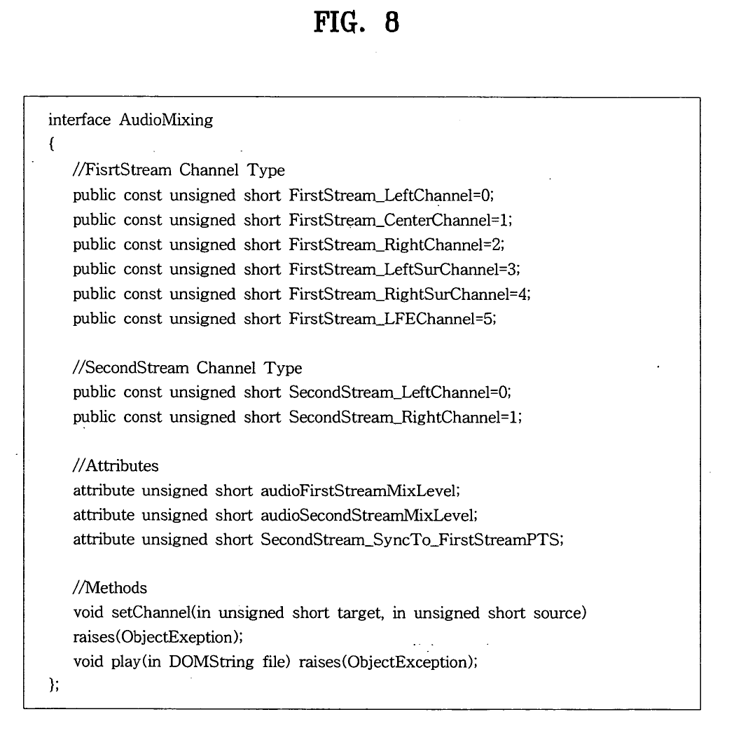

FIG. 8 illustrates an example of programming code of an interface, such as an API, that defines mixing information according to the present invention. The interface of FIG. 8 represents an interface between a platform and a markup data using IDL Definition. Referring to FIG. 8, a first stream channel type indicates respective channels of a target audio stream for audio mixing with predetermined integers. In general, the first stream denotes a conventional DVD-audio or an audio stream stored in a Blu-ray Disc (BD). A second stream channel type also indicates respective channels of a target audio stream for audio mixing, using predetermined integers. In general, the second stream denotes an audio stream that is additionally reproduced together with audio data stored in a DVD or a BD. In this disclosure, two stream channels are described for convenience, but a number of channels is not limited.

In the attributes section of FIG. 8, audioFirstStreamMixLevel and audioSecondStreamMixLevel denote mixing coefficients used to mix the first and second streams, i.e., the volume levels of the first and second streams. The mixing levels are determined by coefficients ranging from 0 to 255. Also, SecondStream_SyncTo_FirstStreamPTS denotes reference timing information for audio mixing, indicating that the second audio stream is reproduced in synchronization with the first audio stream at particular points PTS of the first audio stream.

Also, the interface of FIG. 8 illustrates a setchannel( ) method of mixing predetermined channel components of the first and second audio streams, and a play( ) method for audio data reproduction.

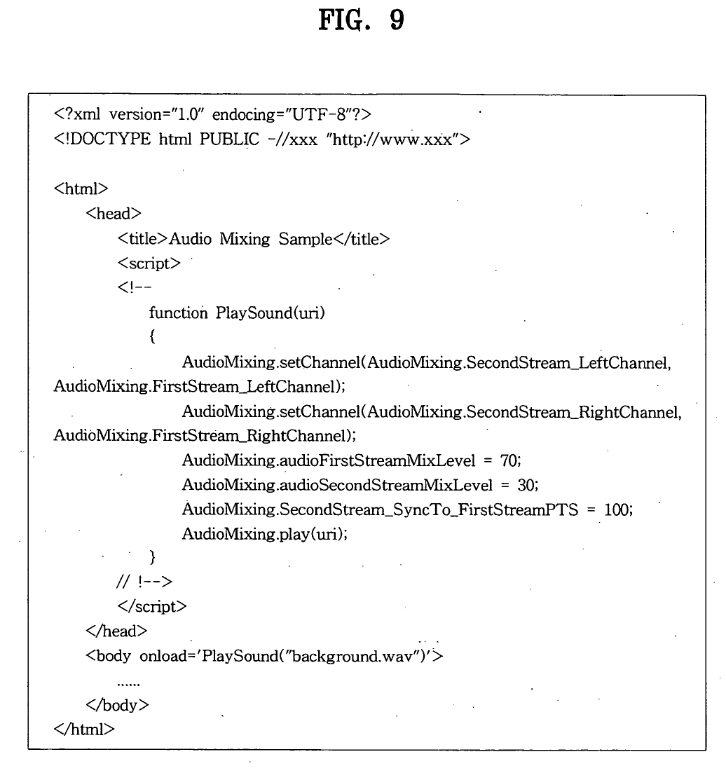

FIG. 9 illustrates an example of code of the interface of FIG. 8 that defines mixing information added to a markup document using ECMAScript.

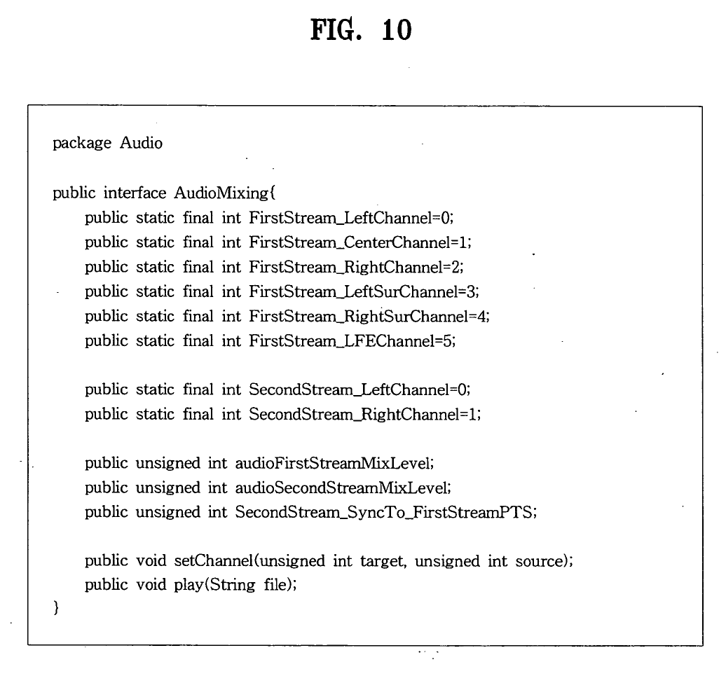

FIG. 10 illustrates an example of code of a JAVA Package that defines IDL Definition shown in FIG. 8 so as to use the IDL Definition in a java program. In fact, import of the JAVA package into a java program enables use of the attributes and methods defined in FIG. 8.

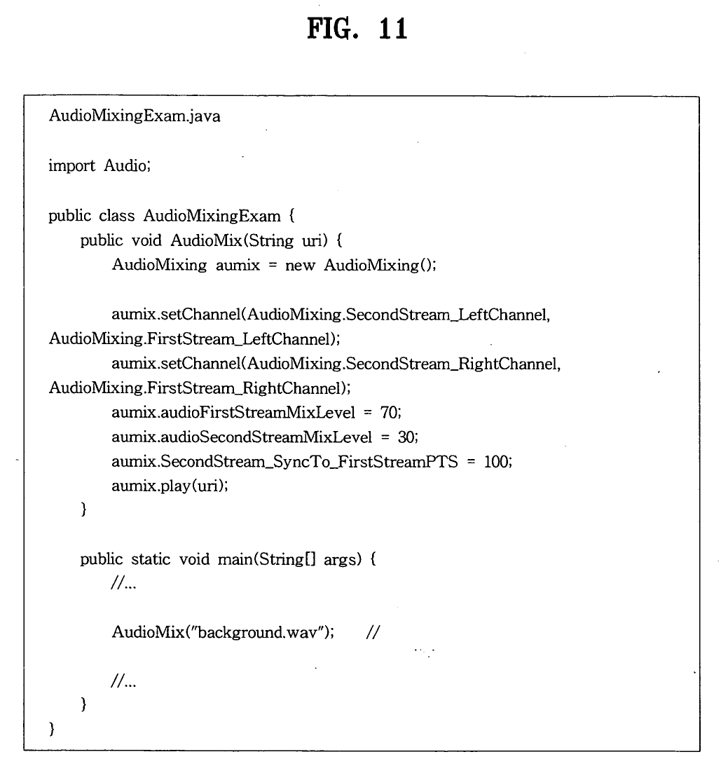

FIG. 11 illustrates an example of code of a java program to which mixing information is added using the JAVA Package of FIG. 10.

Hereinafter, a method of reproducing audio data according to an embodiment of the present invention will be described with reference to the accompanying drawings.

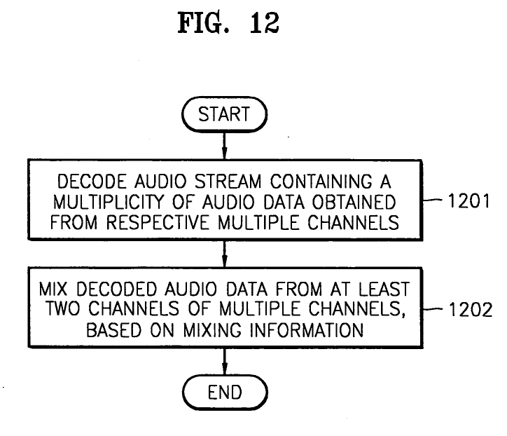

FIG. 12 is a flowchart illustrating a method of reproducing an audio stream according to an embodiment of the present invention. Referring to FIG. 12, the reproducing apparatus decodes an audio stream containing a multiplicity of audio data obtained from respective multiple channels (operation 1201). Next, the decoded audio data from at least two channels of the multiple channels is mixed based on mixing information (operation 1202). Here, the multiplicity of audio data may belong to either a single audio stream or different audio streams.

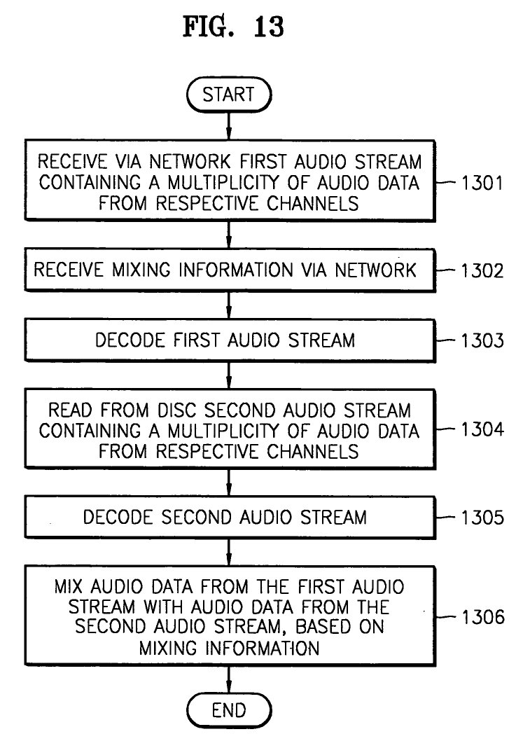

FIG. 13 is a flowchart illustrating a method of reproducing an audio stream according to another embodiment of the present invention. Referring to FIG. 13, a reproducing apparatus receives, via a network, a first audio stream containing a multiplicity of audio data, which is obtained from respective multiple channels (operation 1301). Next, the reproducing apparatus receives mixing information via the network (operation 1302). Next, the first audio stream received via the network is decoded (operation 1303). Next, a second audio stream containing a multiplicity of audio data, which is obtained from respective multiple channels, is read from a disc-type information storage medium (operation 1304). Next, the second audio stream is decoded (operation 1305). Next, the reproducing apparatus mixes audio data from the first audio stream, and audio data from the second audio stream, based on the mixing information (operation 1306).

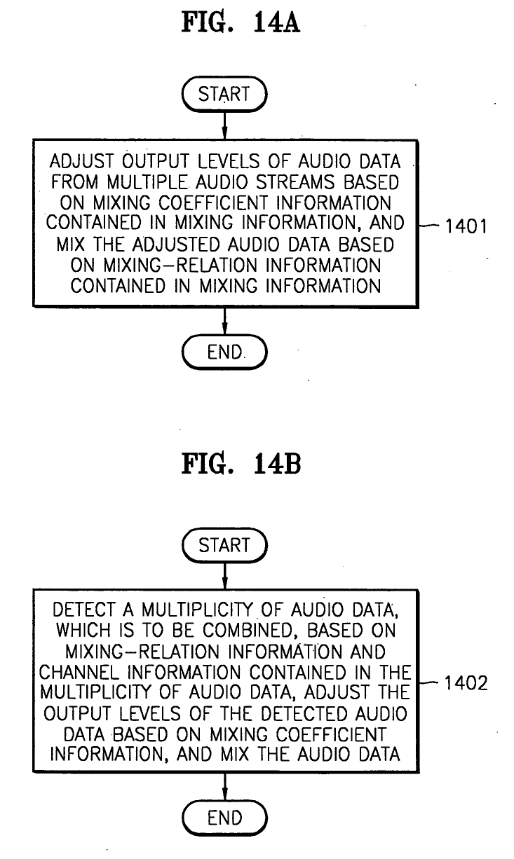

FIGS. 14A and 14B illustrate embodiments of operation 1306 of FIG. 13. Referring to FIG. 14A, a reproducing apparatus adjusts the output levels of audio data from multiple audio streams, based on mixing coefficient information contained in mixing information, and mixes the adjusted audio data based on mixing-relation information contained in the mixing information (operation 1401).

Referring to FIG. 14B, a reproducing apparatus detects a multiplicity of audio data, which is to be combined, based on mixing-relation information and channel information contained in the multiplicity of audio data; adjusts the output levels of the detected multiplicity of audio data based on mixing coefficient information, and mixes the adjusted multiplicity of audio data (operation 1402).

As described above, according to the present invention, it is possible to mix and reproduce different types of channel components without changing the channel formats of different audio streams. Furthermore, it is also possible to perform dynamic mixing on multiple channel components, thus enabling adaptation to a change in audio content and characteristics thereof and thereby reproducing audio data more appropriately. In particular, according to the present invention, since mixing information is described in interactive data allowing an interaction with a user, it is possible to provide the user with more applications.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of reproducing an audio stream, comprising;
decoding at least one audio stream containing a multiplicity of audio data obtained from respective multiple channels; and
mixing audio data from at least two channels of the multiple channels, based on mixing information recorded in interactive data.

2. The method of claim 1, wherein the mixing of the audio data comprises mixing the audio data obtained from at least two channels of the multiple channels, based on mixing information recorded in a markup document in a markup language that enables an interaction with a user or is recorded in program data which is recorded in a different file from the markup document and provides the user with a predetermined application.

3. The method of claim 1, wherein the mixing of the audio data comprises adjusting output levels of the audio data and mixing the adjusted output levels, based on the mixing information including stream channel type information and attributes of the stream channel type information, the stream channel type information that specifies the multiplicity of audio data and obtained from the respective multiple channels using predetermined integers, and the attributes that represent mixing coefficient information specifying the output levels of the multiplicity of audio data and output from the channels.

4. A method of reproducing an audio stream, comprising;
decoding at least one audio stream containing a multiplicity of audio data obtained from multiple channels; and
mixing and reproducing audio data from at least two channels of the multiple channels, based on mixing information recorded in interactive data, without changing channel formats of different audio streams.

5. An audio mixing method, comprising:
mixing and reproducing different types of channel components without changing channel formats of audio streams, constituting different types of audio content.

6. A method of reproducing an audio stream, comprising:
detecting a multiplicity of audio data, which is to be combined, based on mixing-relation information and channel information contained in the multiplicity of audio data;
adjusting output levels of the detected multiplicity of audio data based on mixing coefficient information; and
mixing the adjusted multiplicity of audio data.
